(19) United States
(12) Patent Application Publication
(10) Pub. No.: US 2025/0182250 A1
(43) Pub. Date: Jun. 5, 2025

(54) IMAGE DATA OBTAINMENT DEVICE AND SYSTEM INCLUDING THE SAME

(71) Applicants: Samsung Display Co., LTD., Yongin-si (KR); Seoul National University R&DB Foundation, Seoul (KR)

(72) Inventors: Kyu Su AHN, Yongin-si (KR); Jae Jin LEE, Seoul (KR); Byeong Hyun KO, Incheon (KR); Chan Woo PARK, Seoul (KR); Hyun Gyu LEE, Seoul (KR)

(73) Assignees: Samsung Display Co., LTD., Yongin-si (KR); Seoul National University R&DB Foundation, Seoul (KR)

(21) Appl. No.: 18/923,021

(22) Filed: Oct. 22, 2024

(30) Foreign Application Priority Data
Nov. 30, 2023 (KR) 10-2023-0171444

(51) Int. Cl. G06T 5/60; H04N 23/51

(52) U.S. Cl. CPC G06T 5/60; H04N 23/51; G06T 2207/20081

(57) ABSTRACT

An image data obtainment device includes a camera module, a pattern mount part, and a housing in which the camera module is positioned. The camera module generates image data for image restoration training. The pattern mount part may selectively position a dummy pattern on the camera module. The pattern mount part is positioned on the housing.

### CROSS-REFERENCE TO RELATED APPLICATIONS

This application claims priority under 35 U.S.C. § 119 from Korean Patent Application No. 10-2023-0171444 filed on Nov. 30, 2023 in the Korean Intellectual Property Office, the entire content of which are incorporated herein by reference.

### BACKGROUND

### 1. Technical Field

The disclosure relates to an image data obtainment device and a system including the same.

### 2. Description of the Related Art

An electronic device (for example, a mobile device) is released in various sizes according to a function and a user's preference, and may include a large-screen touch display for ensuring wide visibility and convenience of an operation. The electronic device may include at least one camera module (for example, image sensor). For example, the electronic device may include at least one under display camera (UDC) disposed under (for example, below) a display. A general electronic device includes a display area and a camera area, and since a display may not be driven in the camera area, a partial area of the display cannot display an image. On the other hand, an electronic device to which the UDC is applied may display an image in the entire display area because the display may be driven also in the camera area (for example, a UDC area).

### SUMMARY

A technical object to be solved is to provide an image data obtainment device generating image data for more improved image restoration training.

According to an embodiment of the disclosure, an image data obtainment device of the disclosure may include a camera module and a pattern mount part. The camera module may generate image data. The pattern mount part may selectively position a dummy pattern on the camera module.

In an embodiment, the generated image data may include first image data and second image data, the first image data may be generated in case that the dummy pattern is at a first position to allow external light to pass through the dummy pattern to enter the camera module. The second image data may be generated in case that the dummy pattern is at a second position to allow external light to enter the camera module without passing through the dummy pattern.

In an embodiment, the image data obtainment device may further include a housing in which the camera module may be positioned. The pattern mount part may be positioned on the housing.

In an embodiment, the pattern mount part may include the dummy pattern corresponding to a display pattern disposed on an under display camera, and a body mechanically coupled to the dummy pattern.

In an embodiment, the dummy pattern may be disposed on a dummy pattern carrier part. The body may include a guide to move the dummy pattern carrier part. The dummy pattern carrier part may engage with the guide to move to one of the first position or the second position.

In an embodiment, the guide may include a groove disposed in a straight line on an inner surface of a cavity disposed in the body. The dummy pattern carrier part may include a protrusion engaged with the groove.

In an embodiment, the guide may include a protrusion disposed in a straight line on an inner surface of a cavity formed in the body. The dummy pattern carrier part may include a groove engaged with the protrusion.

In an embodiment, the dummy pattern may be disposed on a dummy pattern carrier part. The pattern mount part may further include a hinge. The hinge may be coupled to the body to move the dummy pattern carrier part. The dummy pattern carrier part may move to one of the first position or the second position by opening or closing about the hinge. In an embodiment, the dummy pattern may be disposed on a dummy pattern carrier part. The pattern mount part may further include a fixing pin. The fixing pin may be coupled to the body to move the dummy pattern carrier part. The dummy pattern carrier part may move from the first position to the second position by rotating clockwise about the fixing pin.

In an embodiment, the dummy pattern may be disposed on a dummy pattern carrier part. The pattern mount part may further include a fixing pin. The fixing pin may be coupled to the body to move the dummy pattern carrier part. The dummy pattern carrier part to move from the first position to the second position by rotating counterclockwise about the fixing pin.

In an embodiment, the pattern mount part may further include an actuator to move the dummy pattern to the first position or the second position.

According to an embodiment of the disclosure, a system may include an image data obtainment device configured to generate first and second image data, and an image restoration module configured to receive the first and second image data and perform restoration training. The image data obtainment device may include a camera module configured to generate the first and second image data, and a pattern mount part configured to selectively position a dummy pattern on the camera module.

In an embodiment, the first image data may be generated in case that the dummy pattern is at a first position where external light passes through the dummy pattern to enter the camera module, and the second image data may be generated in case that the dummy pattern is at a second position where external light may enter the camera module without passing through the dummy pattern.

In an embodiment, the image data obtainment device may further include a housing in which the camera module may be positioned. The pattern mount part may be positioned on the housing.

In an embodiment, the pattern mount part may include the dummy pattern corresponding to a display pattern disposed on an under display camera, and a body mechanically coupled to the dummy pattern.

In an embodiment, the dummy pattern may be disposed on a dummy pattern carrier part. The body may include a guide to move the dummy pattern carrier part. The dummy pattern carrier part may engage with the guide to move to one of the first position or the second position.

In an embodiment, the guide may include a groove disposed in a straight line on an inner surface of a cavity formed in the body. The dummy pattern carrier part may include a protrusion engaged with the groove.

In an embodiment, the guide may include a protrusion disposed in a straight line on an inner surface of a cavity formed in the body. The dummy pattern carrier part may include a groove engaged with the protrusion.

In an embodiment, the dummy pattern may be disposed on a dummy pattern carrier part. The pattern mount part may further include a hinge. The hinge may be coupled to the body to allow for movement of the dummy pattern carrier part. The dummy pattern carrier part may move to one of the first position or the second position by opening or closing about the hinge.

In an embodiment, the dummy pattern may be disposed on a dummy pattern carrier part. The pattern mount part may further include a fixing pin. The fixing pin may be coupled to the body to allow for movement of the dummy pattern carrier part. The dummy pattern carrier part may move from the first position to the second position by rotating counterclockwise about the fixing pin.

In accordance with an image data obtainment device according to the disclosure, image data for more improved image restoration training may be generated.

### BRIEF DESCRIPTION OF THE DRAWINGS

The above and other features of the disclosure will become more apparent by describing in further detail embodiments thereof with reference to the accompanying drawings, in which:

FIG. 1 is a schematic diagram illustrating an embodiment of a mobile device equipped with an under display camera;

FIG. 2 is a schematic diagram illustrating a display pattern on the under display camera of FIG. 1;

FIG. 3 is a schematic diagram illustrating an embodiment of a mobile device equipped with a camera module for reference image capturing;

FIG. 4 is a schematic diagram illustrating an image data obtainment device according to an embodiment of the disclosure;

FIG. 5 is a schematic block diagram illustrating a system for training an image restoration module using first and second image data;

FIG. 6 is a schematic block diagram illustrating a method of recovering deteriorated image data using a trained image restoration module;

FIG. 7 is a schematic diagram illustrating a difference between the first and second image data obtained according to a method of FIG. 4;

FIG. 8A is a schematic diagram illustrating the first image data generated by a first camera module of FIG. 7;

FIG. 8B is a schematic diagram illustrating the second image data generated by a second camera module of FIG. 7;

FIG. 9 is a schematic diagram illustrating an image data obtainment device according to an embodiment of the disclosure;

FIGS. 10A and 10B are schematic cross-sectional views illustrating an operation of the image data obtainment device of FIG. 9;

FIGS. 11A and 11B are schematic diagrams illustrating an embodiment of a pattern mount part included in the image data obtainment device;

FIGS. 12A and 12B are schematic cross-sectional views of the pattern mount part shown in FIGS. 11A and 11B, respectively;

FIGS. 13A and 13B are schematic diagrams illustrating an embodiment of the pattern mount part included in the image data obtainment device;

FIGS. 14A and 14B are schematic cross-sectional views of the pattern mount part shown in FIGS. 13A and 13B, respectively;

FIGS. 15A and 15B are schematic diagrams illustrating an embodiment of the pattern mount part included in the image data obtainment device;

FIG. 16 is a schematic block diagram illustrating a system for training an image restoration module using an image data obtainment device according to an embodiment of the disclosure; and

FIG. 17 is a schematic block diagram illustrating a method of recovering deteriorated image data using a trained image restoration module.

### DETAILED DESCRIPTION OF THE EMBODIMENTS

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the invention. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals and/or reference characters denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the X-axis, the Y-axis, and the Z-axis are not limited to three axes of a rectangular coordinate system, such as the x, y, and z axes, and may be interpreted in a broader sense. For example, the X-axis, the Y-axis, and the Z-axis may be perpendicular to one another, or may represent different directions that are not perpendicular to one another.

For the purposes of this disclosure, “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined or implied herein, all terms (including technical and scientific terms) used herein have the same meaning as commonly understood by those skilled in the art to which this disclosure pertains. It will be further understood that terms, such as those defined in commonly used dictionaries, should be interpreted as having a meaning that is consistent with their meaning in the context of the relevant art and the disclosure, and should not be interpreted in an ideal or excessively formal sense unless clearly so defined herein.

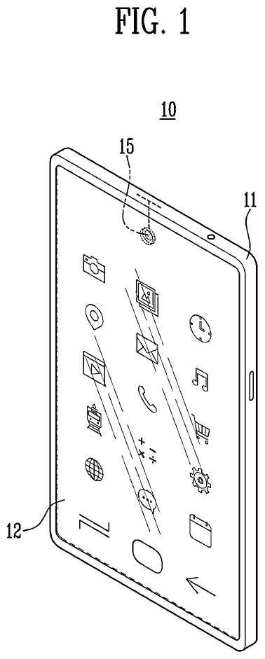

FIG. 1 is a schematic diagram illustrating an embodiment of a mobile device equipped with an under display camera.

Referring to FIG. 1, the mobile device 10 may include a housing 11, a display panel 12 coupled to the housing 11, and a camera module 15. As an embodiment, the camera module 15 may be disposed under the display panel 12 or inside the display panel 12. For example, in case that the camera module 15 is disposed in an under display camera (UDC) method, an area corresponding to an upper portion of the camera module 15 in the display panel 12 may display an image.

In an under display camera, since light (e.g., external light) is required to enter a lens of a camera through the display panel, a transmittance of the light entering the camera module may be reduced. An opaque area having a pattern arrangement on the display panel may partially further reduce the transmittance of the entering light.

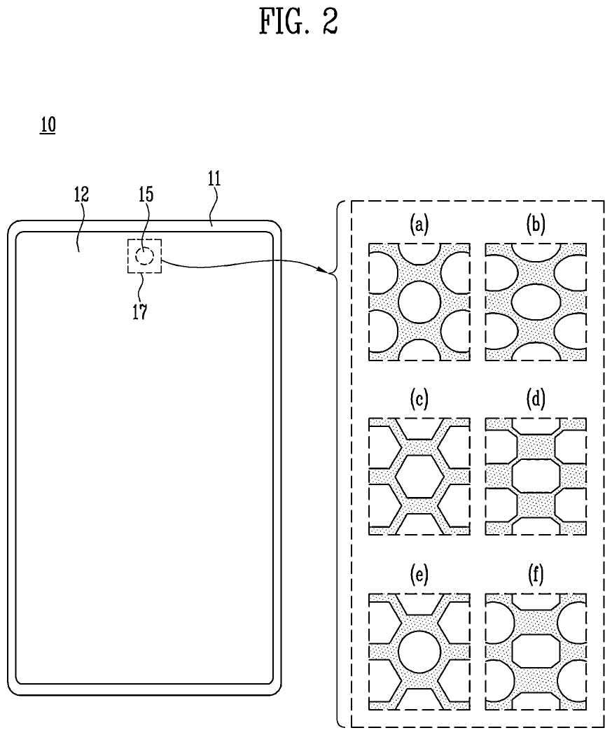

FIG. 2 is a schematic diagram illustrating a display pattern on the under display camera of FIG. 1.

Referring to FIG. 2, the mobile device 10 including the camera module 15 disposed in a form of the under display camera is shown. As described above, the mobile device 10 may include the housing 11, the display panel 12 coupled to the housing 11, and the camera module 15. The display panel 12 may include a pattern area 17 on the camera module 15. In an embodiment, in case that the camera module 15 is not operating, the display panel 12 may display an image on the pattern area 17, and while the camera module 15 is operating, the display panel 12 may display an image on the pattern area 17.

To this end, the pattern area 17 may also include a pattern for displaying an image equally or similarly to a remaining area of the display panel 12. As an example, the pattern area 17 on the camera module 15 may include a regular pattern or a predetermined or selectable pattern as shown in (a) to (f) of FIG. 2. However, the pattern of (a) to (f) of FIG. 2 is exemplary, and the pattern formed in the pattern area 17 in the display panel 12 may include regular or irregular patterns.

Each of the patterns shown in (a) to (f) of FIG. 2 may include an opaque area, and thus a diffraction phenomenon by patterns may occur in light passing through the pattern area 17. The opaque area included in the patterns shown in (a) to (f) of FIG. 2 may reduce an amount of light incident on the camera module 15. Accordingly, image data captured by the camera module 15 disposed in the under display method may appear with deteriorated image quality.

An image restoration module may be used to recover image data with deteriorated image quality. In an embodiment, the image restoration module may restore the image data with deteriorated image quality using a deep learning algorithm so that the image data with deteriorated image quality is close to an original capturing object. Deep learning may be a field of machine learning and may be a method of learning data through successive layers of an artificial neural network. In case that implementing the image restoration module using a deep learning technique, a sufficiently large data set is required. As an example, for the deep learning technique for recovering image data, an image data pair that pairs image data with deteriorated image quality and image data with good quality which may not be deteriorated may be required. Since the image data with deteriorated image quality may be obtained through the camera module 15 of the mobile device shown in FIGS. 1 and 2, an additional device for obtaining the image data with good quality may be required.

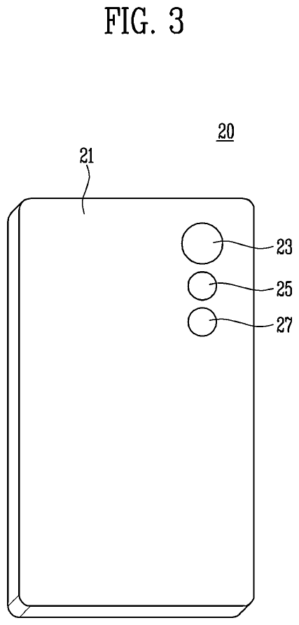

FIG. 3 is a schematic diagram illustrating an embodiment of a mobile device equipped with a camera module for reference image capturing.

Referring to FIG. 3, the mobile device 20 may include a housing 21 and first to third camera modules 23, 25, and 27. The first to third camera modules 23, 25, and 27 may have different viewing angles and resolutions. However, this is an example, and the mobile device may include only one camera module. Although not shown in FIG. 3, the mobile device 20 may include a display panel. The display panel may be mounted on a surface opposite to a surface where the first to third camera modules 23, 25, and 27 may be provided. The first to third camera modules 23, 25, and 27 may configure a general camera other than an under display camera. The image data with good quality which may not be deteriorated by the display pattern may be obtained using one of the first to third camera modules 23, 25, and 27. As an example, in case that the second camera module 25 among the first to third camera modules 23, 25, and 27 has the smallest viewing angle difference as compared to the camera module 15 configuring the under display camera, the image data with good quality for configuring the image data pair may be obtained using the second camera module 25.

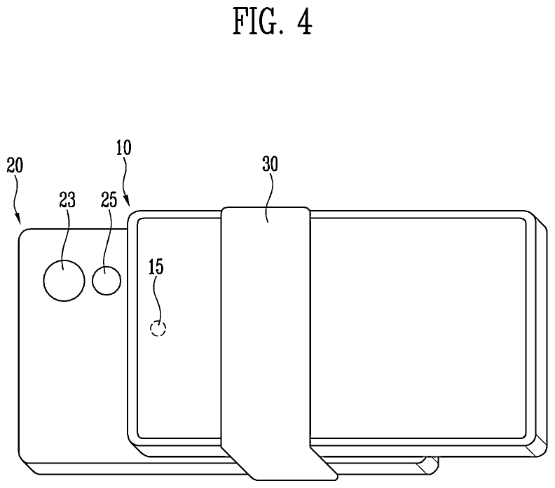

FIG. 4 is a schematic diagram illustrating an image data obtainment device according to an embodiment of the disclosure.

Referring to FIG. 4, the image data obtainment device may include multiple mobile devices 10 and 20. The camera module 15 of the mobile device 10 may be the under display camera, and may obtain deteriorated image data by the camera module 15. The camera module 25 of the mobile device 20 may configure the general camera other than the under display camera, and may obtain the image data with good quality which may not be deteriorated. In this specification, the image data with good quality which may not be deteriorated is referred to as first image data, and the image data deteriorated by the display pattern is referred to as second image data.

In an embodiment, the image data obtainment device may include a fixing part 30 for coupling and fixing the mobile devices 10 and 20. The fixing part 30 may couple the mobile devices 10 and 20 to each other while the camera modules 15 and 25 of the respective mobile devices 10 and 20 obtain image data.

As an embodiment, in order to reduce a viewing angle difference between the first image data and the second image data, the fixing part 30 may fix the mobile devices 10 and 20 so that the camera module 25 of the mobile device 20 and the camera module 15 of the mobile device 10 may be positioned as close as possible.

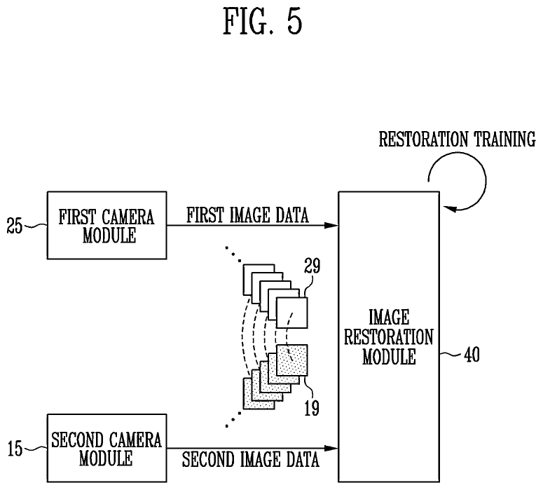

FIG. 5 is a schematic block diagram illustrating a system for training the image restoration module using the first and second image data.

Referring to FIG. 5, the first camera module 25 may obtain first image data 29 and transmit the first image data 29 to an image restoration module 40. The first camera module 25 may configure the general camera other than the under display camera, and may obtain the first image data 29 which may be the image data with good quality which may not be deteriorated, through a capturing operation.

The second camera module 15 may configure the under display camera and may obtain second image data 19 which may be the image data deteriorated by the pattern area 17 of the display panel. At this time, each of multiple first image data 29 may configure the image data pair with a corresponding second image data 19 among multiple second image data 19. The first and second image data 29 and 19 may be transmitted to the image restoration module 40 in the form of the image data pair. In an embodiment, the image restoration module 40 may be electrically connected to the mobile devices 10 and 20 through a communication cable. In case that the first camera module 25 and the second camera module 15 obtain the first image data 29 and the second image data 19, respectively, the first image data 29 and the second image data 19 may be transmitted to the image restoration module 40 in real time.

In an embodiment, the first image data 29 and the second image data 19 obtained by the first camera module 25 and the second camera module 15 may be stored in a storage medium included in each of the mobile devices 20 and 10, respectively. Thereafter, the first image data 29 and the second image data 19 stored in the storage medium may be transmitted to the image restoration module 40.

The image restoration module 40 may perform restoration training based on the received first and second image data 29 and 19. As described above, the image restoration module 40 may perform the restoration training through deep learning using multiple image data pairs.

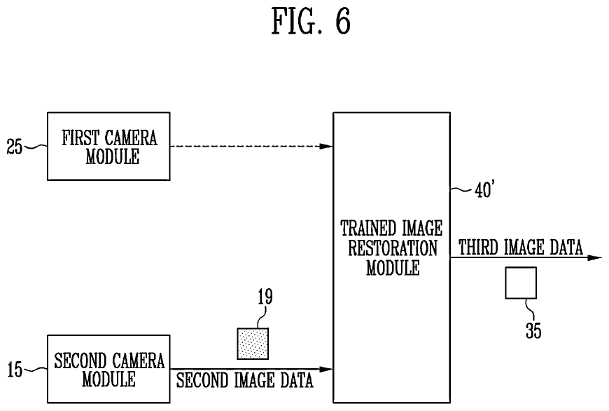

FIG. 6 is a schematic block diagram illustrating a method of recovering deteriorated image data using a trained image restoration module.

Referring to FIG. 6, the second image data 19 generated by capturing of the second camera module 15 may be transmitted to a trained image restoration module 40′. The image restoration module 40′ may be in a trained state using a large amount of image data pairs as described with reference to FIG. 5, and may generate third image data 35 by recovering the received second image data 19. The third image data 35 may have image quality equal to or comparable to that of the first image data generated by the first camera module 25.

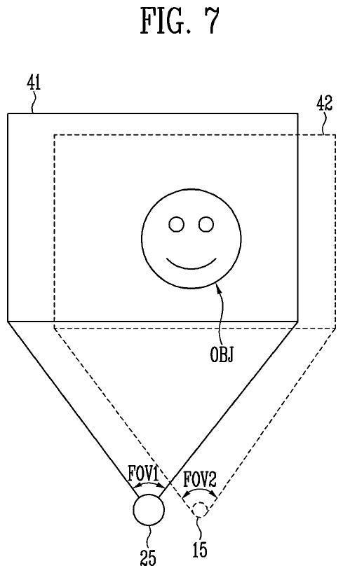

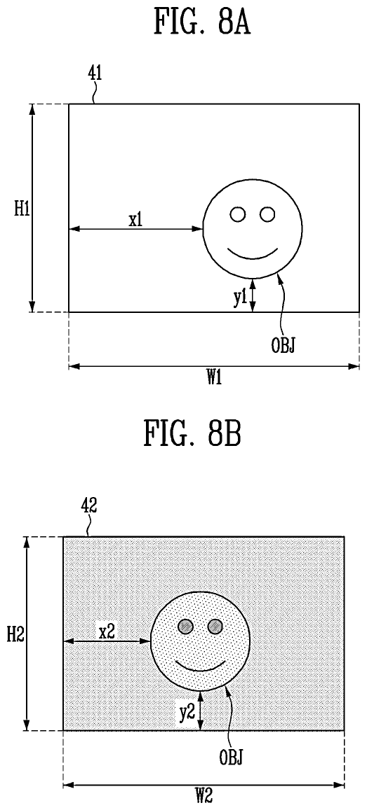

FIG. 7 is a schematic diagram illustrating a difference between the first and second image data obtained according to the method of FIG. 4. FIG. 8A is a schematic diagram illustrating the first image data generated by the first camera module of FIG. 7. FIG. 8B is a schematic diagram illustrating the second image data generated by the second camera module of FIG. 7. Hereinafter, the disclosure may be described with reference to FIGS. 7, 8A, and 8B together.

Referring to FIG. 7, capturing areas 41 and 42 of image data generated in case that the first and second camera modules 25 and 15 capture an object OBJ are shown. The first and second camera modules 25 and 15 shown in FIG. 4 may be camera modules having different specifications. For example, viewing angles or resolutions of the first and second camera modules 25 and 15 may be different from each other. Since each of the first and second camera modules 25 and 15 does not capture the object OBJ at the same position, a parallax exists between the first and second camera modules 25 and 15, which means that a field of view FOV1 of the first camera module 25 and a field of view FOV2 of the second camera module 15 may be different from each other. Accordingly, the capture area 41 of the image data generated by the first camera module 25 and the capture area 42 of the image data generated by the second camera module 15 may become different from each other.

Specifically, as shown in FIG. 8A, the image data generated by the first camera module 25 may include image data for the capture area 41. Each capture area may have a width W1 and a height H1. In the capture area 41, the object OBJ may have a horizontal position x1 and a vertical position y1.

As shown in FIG. 8B, the image data generated by the second camera module 15 may include image data for the capture area 42. Each capture area may have a width W2 and a height H2. In the capture area 42, the object OBJ may have a horizontal position x2 and a vertical position y2. Since the second camera module 15 may be configured as the under display camera, the image data generated by the second camera module 15 may be shaded.

As described above, since the viewing angles of the first and second camera modules 25 and 15 may be different, the width W1 and the height H1 of the capture area 41 of the image data generated by the first camera module 25 may be different from the width W2 and the height H2 of the capture area 42 of the image data generated by the second camera module 15, respectively. Since the viewing angles and the positions of the first and second camera modules 25 and 15 may be different, the horizontal and vertical positions x1 and y1 of the object OBJ in the capture area 41 of the image data generated by the first camera module 25 may be different from the horizontal and vertical positions x2 and y2 of the object OBJ in the capture area 42 of the image data generated by the second camera module 15.

In image restoration training using the deep learning algorithm, in case that the position and the size of the object OBJ in the first image data is similar to the position and the size of the object OBJ in the second image data, a result of restoration training may be better. The most desirable training result may be derived in case that the size and the position of the object OBJ are the same in the first and second image data, and an image restoration operation according thereto may also be successfully performed.

However, in case that the first and second image data captured as shown in FIGS. 8A and 8B are used for restoration training, since the capture area of each image data may be different and the position of the object OBJ in each capture area may be different, a result of restoration training may be inadequate. Therefore, the size and the position of the object OBJ may be required to match in the first and second image data. However, as described above, in case that the specifications of the first and second camera modules are different, since the size of the capture area may be different, even though the image data may be resized to the same resolution, the size of the object OBJ in the capture area of each image data may be different.

Even though the first and second camera modules have the same specification, a parallax may occur since the positions of the first and second cameras may be different. The position of the object OBJ in the capture area of each image data may be different.

In accordance with an image data obtainment device according to an embodiment of the disclosure, the image data obtainment device includes a means for selectively positioning a dummy pattern equal or similar to a display pattern on a camera module. Accordingly, a camera module may generate the first and second image data without changing a position and a viewing angle. Accordingly, a result of restoration training for image restoration may be improved, and as a result, quality of restored image data generated by the image restoration module may also be improved.

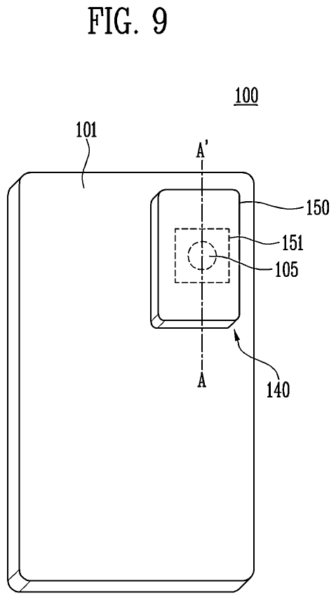

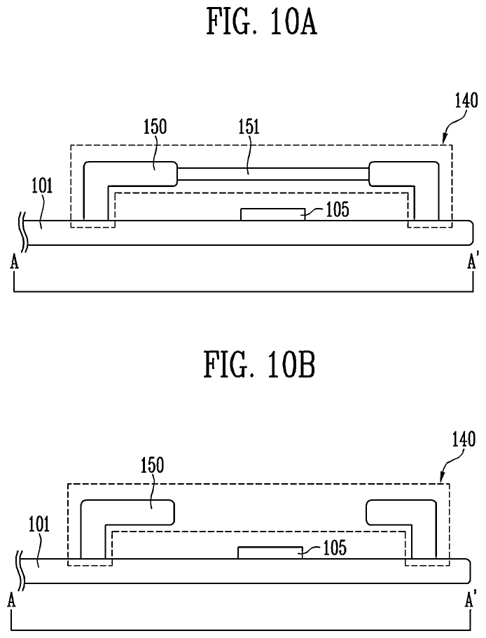

FIG. 9 is a schematic diagram illustrating an image data obtainment device according to an embodiment of the disclosure. FIGS. 10A and 10B may be schematic cross-sectional views illustrating an operation of the image data obtainment device of FIG. 9. In particular, FIGS. 10A and 10B are schematic cross-sectional views of the image data obtainment device taken along A-A′ of FIG. 9. Hereinafter, an image data obtainment device according to an embodiment of the disclosure may be described with reference to FIGS. 9, 10A, and 10B together.

Referring to FIG. 9, the image data obtainment device 100 includes a housing 101, a camera module 105, and a pattern mount part 140. The pattern mount part 140 may include a dummy pattern 151 and a body 150.

The housing 101 and the camera module 105 may be included in an existing commercially available mobile device. At this time, the camera module 105 may be the general camera other than the under display camera. For example, the housing 101 may be a housing of a general mobile phone or tablet PC. Although not shown in FIG. 9, the camera module 105 may be a camera provided on a rear surface of the mobile phone other than a front surface where the display panel may be formed. The image data obtainment device 100 may include a mobile device.

However, this may be an example, and the housing 101 and the camera module 105 may not be included in the mobile device. The housing 101 may include only the camera module 105 and circuits related thereto. The image data obtainment device 100 according to the disclosure may be implemented with only the camera module without a mobile device.

The body 150 of the pattern mount part 140 may be fixed to the housing 101. The body 150 may be mechanically coupled to the dummy pattern 151. According to an embodiment of the disclosure, a position of the dummy pattern 151 may not be fixed, and the dummy pattern 151 may be coupled to the body 150 so as to be in at least two different positions. The dummy pattern 151 may include a pattern equal or similar to the display pattern formed on the under display camera. However, the pattern formed on the dummy pattern 151 may not configure the display panel.

FIG. 10A is a schematic cross-sectional view of the image data obtainment device taken along line A-A′ of FIG. 9 in case that the dummy pattern 151 is at a first position. Referring to FIG. 10A, in case that the dummy pattern 151 is at the first position, light (e.g., external light) may pass through the dummy pattern 151 and enter the camera module 105. The image data generated by the camera module 105 while the dummy pattern 151 may be at the first position may correspond to the deteriorated image data generated by the camera module configured as the under display camera.

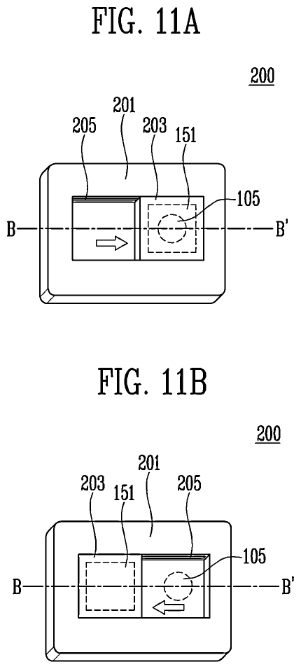

FIG. 10B is a schematic cross-sectional view of the image data obtainment device taken along A-A′ of FIG. 9 in case that the dummy pattern 151 is at the second position. According to an embodiment of the disclosure, the second position of the dummy pattern 151 may be an arbitrary position other than an upper portion of the camera module 105. Therefore, in FIG. 10B, the dummy pattern 151 of the second position may be omitted, and a specific position of the dummy pattern according to a detailed embodiment of the disclosure may be described with reference to FIGS. 11A to 15B.

Referring to FIG. 10B, in case that the dummy pattern 151 is at the second position, light may enter the camera module 105 without passing through the dummy pattern 151. The image data generated by the camera module 105 while the dummy pattern 151 is at the second position may correspond to the image data with good quality generated by the camera module configured as the general camera other than the under display camera.

The image data obtainment device according to an embodiment of the disclosure includes the pattern mount part 140 configured to selectively position the dummy pattern 151 on the camera module 105. Accordingly, a camera module 105 may generate both of the image data deteriorated by the dummy pattern and the image data with good quality which may not be deteriorated without changing a position and a viewing angle. Accordingly, a result of restoration training for image restoration may be improved, and as a result, quality of restored image data generated by the image restoration module may also be improved.

FIGS. 11A and 11B are schematic diagrams illustrating an embodiment of the pattern mount part included in the image data obtainment device.

Referring to FIGS. 11A and 11B together, the pattern mount part 200 includes a body 201 and a dummy pattern carrier part 203. A dummy pattern 151 equal or similar to the display pattern may be formed (or disposed) in the dummy pattern carrier part 203. The body 201 may be formed with a guide 205 for moving the dummy pattern carrier part 203. The guide 205 may be a groove formed in a straight line in a rail shape on an inner surface of a cavity formed in a rectangular shape in the body 201. A protrusion may be formed on a side surface of the dummy pattern carrier part 203 and may engage with the groove shape of guide 205.

Conversely, the guide 205 may be a protrusion formed in a straight line in a rail shape on the inner surface of the rectangular shape of cavity formed in the body 201. A groove may be formed on a side surface of the dummy pattern carrier part 203, and thus may engage with the protrusion shape of guide 205. In either case, the dummy pattern carrier part 203 may move left and right along a rail. The dummy pattern carrier part 203 may have a shape of a sliding door. FIG. 11A shows the pattern mount part 200 of a case where the dummy pattern carrier part 203 may be moved to the right so that the dummy pattern 151 may be at the first position. FIG. 11B shows the pattern mount part 200 of a case where the dummy pattern carrier part 203 may be moved to the left so that the dummy pattern 151 may be at the second position.

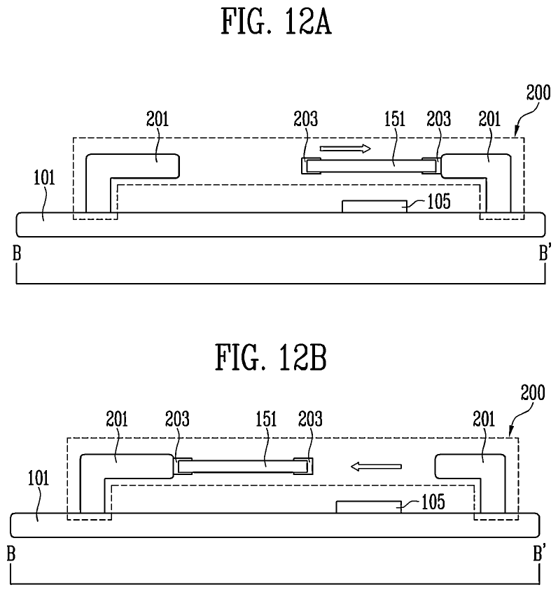

FIGS. 12A and 12B are schematic cross-sectional views of the pattern mount part shown in FIGS. 11A and 11B, respectively. FIG. 12A is a schematic cross-sectional view of the image data obtainment device taken along B-B′ of FIG. 11A in case that the dummy pattern 151 is at the first position. FIG. 12B is a schematic cross-sectional view of the image data obtainment device taken along B-B′ of FIG. 11B in case that the dummy pattern 151 is at the second position.

Referring to FIGS. 11A and 12A, in case that the dummy pattern 151 is at the first position, the dummy pattern 151 may be positioned on the camera module 105. Therefore, light (e.g., external light) may pass through the dummy pattern 151 and enter the camera module 105. Image data generated by the camera module 105 while the dummy pattern 151 is at the first position may correspond to the deteriorated image data generated by the camera module configured as the under display camera.

Referring to FIGS. 11B and 12B, in case that the dummy pattern 151 is at the second position, light (e.g., external light) may enter the camera module 105 without passing through the dummy pattern 151. Image data generated by the camera module 105 while the dummy pattern 151 is at the second position may correspond to the image data with good quality generated by the camera module configured as the general camera other than the under display camera.

In an embodiment, a human may adjust (e.g., directly adjust) a position of the dummy pattern carrier part 203 by hand. In an embodiment, the pattern mount part 200 may electrically adjust the position by movement of the dummy pattern carrier part 203 through an electrically controllable means such as an actuator.

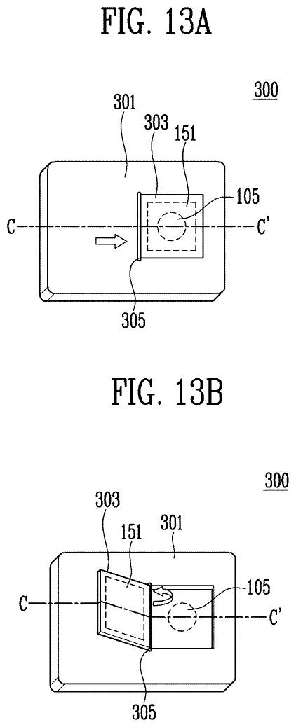

FIGS. 13A and 13B are schematic diagrams illustrating an embodiment of the pattern mount part included in the image data obtainment device.

Referring to FIGS. 13A and 13B together, the pattern mount part 300 includes a body 301, a dummy pattern carrier part 303, and a hinge 305. As described above with reference to FIGS. 11A and 11B, the dummy pattern 151 equal or similar to the display pattern may be formed in the dummy pattern carrier part 303. The body 301 may be physically coupled to the dummy pattern carrier part 303 through the hinge 305. The dummy pattern carrier part 303 may rotate about the hinge 305. The dummy pattern carrier part 303 may have a configuration of a hinged door.

FIG. 13A shows the pattern mount part 300 in a state in which the dummy pattern carrier part 303 may be closed so that the dummy pattern 151 may be at the first position. FIG. 13B shows the pattern mount part 300 in a state in which the dummy pattern carrier part 303 may be opened so that the dummy pattern 151 may be at the second position.

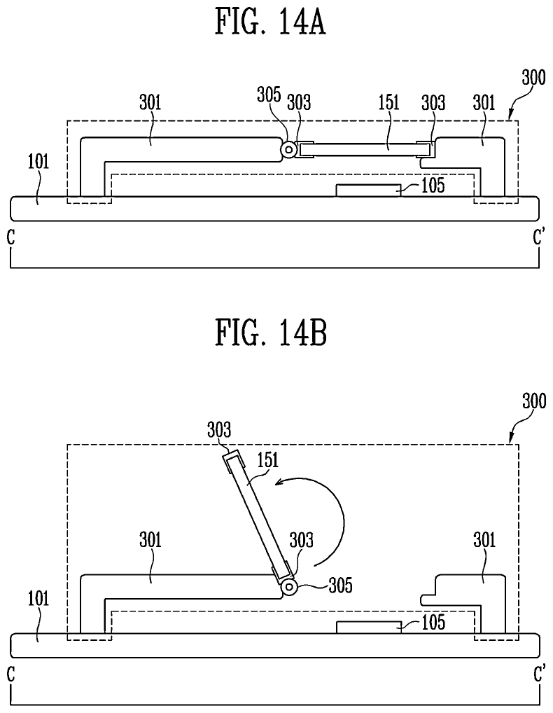

FIGS. 14A and 14B are schematic cross-sectional views of the pattern mount part shown in FIGS. 13A and 13B, respectively. FIG. 14A is a schematic cross-sectional view of the image data obtainment device taken along C-C′ of FIG. 13A in case that the dummy pattern 151 is at the first position. FIG. 14B is a schematic cross-sectional view of the image data obtainment device taken along C-C′ of FIG. 13B in case that the dummy pattern 151 is at the second position.

Referring to FIGS. 13A and 14A, in case that the dummy pattern 151 is at the first position, the dummy pattern 151 may be positioned on the camera module 105. Therefore, light may pass through the dummy pattern 151 and may enter the camera module 105. The image data generated by the camera module 105 while the dummy pattern 151 is at the first position may correspond to the deteriorated image data generated by the camera module configured as the under display camera.

Referring to FIGS. 13B and 14B, in case that the dummy pattern 151 is at the second position, light may enter the camera module 105 without passing through the dummy pattern 151. The image data generated by the camera module 105 while the dummy pattern 151 is at the second position may correspond to the image data with good quality generated by the camera module configured as the general camera other than the under display camera.

In an embodiment, a human may adjust (e.g., directly adjust) a position of the dummy pattern carrier part 303 by hand. In an embodiment, the pattern mount part 300 may electrically adjust the position of the dummy pattern carrier part 303 through an electrically controllable means such as an actuator.

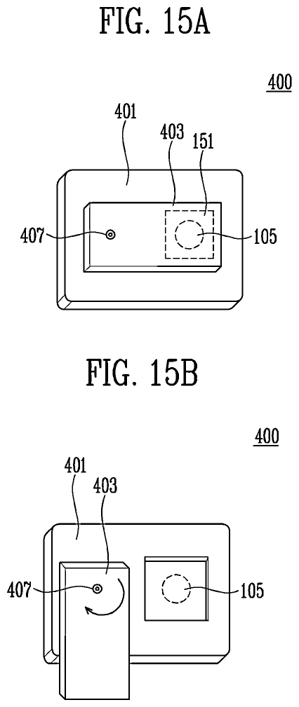

FIGS. 15A and 15B are schematic diagrams illustrating an embodiment of the pattern mount part included in the image data obtainment device. Referring to FIGS. 15A and 15B together, the pattern mount part 400 includes a body 401, a dummy pattern carrier part 403, and a fixing pin 407. As described above, a dummy pattern 151 equal or similar to the display pattern may be formed in the dummy pattern carrier part 403. The body 401 may be physically coupled to the dummy pattern carrier part 403 through the fixing pin 407. As shown in FIG. 15B, the dummy pattern carrier part 303 may rotate clockwise about the fixing pin 407 to move from the first position to the second position. However, this may be an example, and the dummy pattern carrier part 403 may rotate counterclockwise about the fixing pin 407 to move from the first position to the second position.

Embodiments of the pattern mount part included in the image data obtainment device according to an embodiment of the disclosure have been described with reference to FIGS. 11A to 15B. However, the disclosure may not be limited to the embodiment shown in FIGS. 11A to 15B, and may include an arbitrary means for selectively positioning the dummy pattern at the first position on the camera module or at the second position other than an upper portion of the camera module by manipulation. As described above, the pattern mount part included in the image data obtainment device according to an embodiment of the disclosure may be operated by a hand of a human, but may also be operated electrically by being coupled to a device such as an actuator.

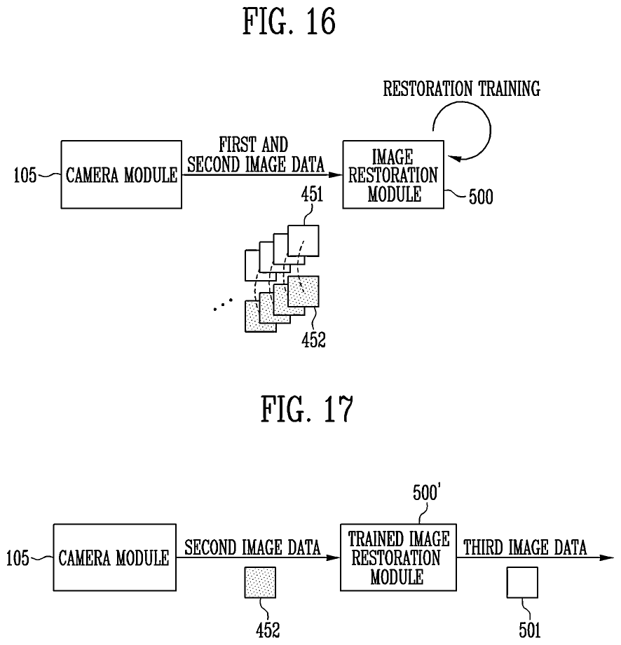

FIG. 16 is a schematic block diagram illustrating a system for training the image restoration module using the image data obtainment device according to an embodiment of the disclosure.

Referring to FIG. 16, the camera module 105 included in the image data obtainment device may obtain both of first image data 451 and second image data 452 and transmit both of the first image data 451 and the second image data 452 to an image restoration module 500 as the image data pair. The image restoration module 500 may perform restoration training based on the received first and second image data 451 and 452. As described above, the image restoration module 500 may perform restoration training through deep learning using multiple image data pairs.

FIG. 17 is a schematic block diagram illustrating a method of recovering the deteriorated image data using a trained image restoration module. Referring to FIG. 17, the second image data 452 generated by capturing of the camera module 105 may be transmitted to the trained image restoration module 500′. The image restoration module 500′ may be in a trained state using a large amount of image data pairs as described with reference to FIG. 16, and may generate third image data 501 by modifying the received second image data 452.

According to an embodiment of the disclosure, by manipulating the pattern mount part included in the image data obtainment device, the dummy pattern 151 may be positioned at the first position on the camera module 105 or at the second position other than an upper portion of the camera module 105. Accordingly, a camera module 105 may generate both of the image data deteriorated by the dummy pattern and the image data with good quality which may not be deteriorated without changing the resolution, position, or the viewing angle. Accordingly, a result of restoration training for image restoration may be improved, and as a result, quality of restored image data generated by the image restoration module may also be improved.

The drawings referred to so far and the detailed description of the disclosure described herein may be merely examples of the disclosure, may be used for merely describing the disclosure, and may not be intended to limit the meaning and the scope of the disclosure described in claims. Therefore, those skilled in the art will understand that various modifications and equivalent other embodiments may be possible from these. Thus, the true scope of the disclosure should be determined by the technical spirit of the appended claims.

What is claimed is:

1. An image data obtainment device comprising:
a camera module configured to generate image data; and
a pattern mount part configured to selectively position a dummy pattern on the camera module.

2. The image data obtainment device according to claim 1, wherein
the generated image data comprises first image data and second image data;
the first image data is generated in case that the dummy pattern is at a first position to allow external light to pass through the dummy pattern to enter the camera module, and
the second image data is generated in case that the dummy pattern is at a second position to allow external light to enter the camera module without passing through the dummy pattern.

3. The image data obtainment device according to claim 2, further comprising:
a housing in which the camera module is positioned,
wherein the pattern mount part is positioned on the housing.

4. The image data obtainment device according to claim 2, wherein the pattern mount part comprises:
the dummy pattern corresponding to a display pattern disposed on an under display camera; and
a body mechanically coupled to the dummy pattern.

5. The image data obtainment device according to claim 4, wherein
the dummy pattern is disposed on a dummy pattern carrier part,
the body includes a guide to move the dummy pattern carrier part, and
the dummy pattern carrier part engages with the guide to move to one of the first position or the second position.

6. The image data obtainment device according to claim 5, wherein
the guide includes a groove disposed in a straight line on an inner surface of a cavity disposed in the body, and
the dummy pattern carrier part includes a protrusion engaged with the groove.

7. The image data obtainment device according to claim 5, wherein
the guide includes a protrusion disposed in a straight line on an inner surface of a cavity formed in the body, and
the dummy pattern carrier part includes a groove engaged with the protrusion.

8. The image data obtainment device according to claim 4, wherein
the dummy pattern is disposed on a dummy pattern carrier part,
the pattern mount part further comprises a hinge coupled to the body to move the dummy pattern carrier part, and
the dummy pattern carrier part to move to one of the first position or the second position by opening or closing about the hinge.

9. The image data obtainment device according to claim 4, wherein
the dummy pattern is disposed on a dummy pattern carrier part,
the pattern mount part further comprises a fixing pin coupled to the body to move the dummy pattern carrier part, and
the dummy pattern carrier part to move from the first position to the second position by rotating clockwise about the fixing pin.

10. The image data obtainment device according to claim 4, wherein
the dummy pattern is disposed on a dummy pattern carrier part,
the pattern mount part further comprises a fixing pin coupled to the body to move the dummy pattern carrier part, and
the dummy pattern carrier part to move from the first position to the second position by rotating counterclockwise about the fixing pin.

11. The image data obtainment device according to claim 4, wherein the pattern mount part further comprises an actuator to move the dummy pattern to the first position or the second position.

12. A system comprising:
an image data obtainment device configured to generate first and second image data; and
an image restoration module configured to receive the first and second image data and perform restoration training,
wherein the image data obtainment device comprises:
a camera module configured to generate the first and second image data; and
a pattern mount part configured to selectively position a dummy pattern on the camera module.

13. The system according to claim 12, wherein
the first image data is generated in case that the dummy pattern is at a first position where external light passes through the dummy pattern to enter the camera module, and
the second image data is generated in case that the dummy pattern is at a second position where external light enters the camera module without passing through the dummy pattern.

14. The system according to claim 13, further comprising:
a housing in which the camera module is positioned,
wherein the pattern mount part is positioned on the housing.

15. The system according to claim 13, wherein the pattern mount part comprises:
the dummy pattern corresponding to a display pattern disposed on an under display camera; and
a body mechanically coupled to the dummy pattern.

16. The system according to claim 15, wherein
the dummy pattern is disposed on a dummy pattern carrier part,
the body includes a guide to move the dummy pattern carrier part, and
the dummy pattern carrier part engages with the guide to move to one of the first position or the second position.

17. The system according to claim 16, wherein
the guide includes a groove disposed in a straight line on an inner surface of a cavity disposed in the body, and
the dummy pattern carrier part includes a protrusion engaged with the groove.

18. The system according to claim 16, wherein
the guide includes a protrusion disposed in a straight line on an inner surface of a cavity disposed in the body, and
the dummy pattern carrier part includes a groove engaged with the protrusion.

19. The system according to claim 15, wherein
the dummy pattern is disposed on a dummy pattern carrier part,
the pattern mount part further comprises a hinge coupled to the body to allow for movement of the dummy pattern carrier part, and
the dummy pattern carrier part to move to one of the first position or the second position by opening or closing about the hinge.

20. The system according to claim 15, wherein
the dummy pattern is disposed on a dummy pattern carrier part,
the pattern mount part further comprises a fixing pin coupled to the body to allow for movement of the dummy pattern carrier part, and
the dummy pattern carrier part to move from the first position to the second position by rotating about the fixing pin.
